(19) United States
(12) Patent Application Publication
(10) Pub. No.: US 2025/0273765 A1
(43) Pub. Date: Aug. 28, 2025

(54) BATTERY SYSTEM WITH INTEGRATED COOLING MANIFOLD

(71) Applicant: SAMSUNG SDI CO., LTD., Yongin-si (KR)

(72) Inventors: Wolfgang DIETZ, Pirching a. Traubenb. (AT); Wolfgang KLEINDIENST, Graz (AT); Daniel KONRAD, Feldbach (AT); Sandi KOLETNIK, Werndorf (AT); Patrick THOMANN, Hengsberg (AT); Markus PRETSCHUH, Graz (AT); Peter KURCIK, Sankt Nikolai im Sausal (AT); Andreas KÖPPEL, Haselsdorf-Tobelbad (AT)

(21) Appl. No.: 18/808,897

(22) Filed: Aug. 19, 2024

(30) Foreign Application Priority Data
Feb. 23, 2024 (EP) 24159433.2

(51) Int. Cl. H01M 10/6568; G01M 3/40; H01M 10/42; H01M 10/613; H01M 10/625; H01M 10/6555; H01M 50/227; H01M 50/233; H01M 50/627

(52) U.S. Cl. CPC H01M 10/6568; G01M 3/40; H01M 10/4228; H01M 10/613; H01M 10/625; H01M 10/6555; H01M 50/227; H01M 50/233; H01M 50/627; H01M 2220/20

(57) ABSTRACT

A battery system includes accommodation chambers on top of each other in a housing with side portions, each one of the accommodation chambers including cells and a cooling plate; a cooling manifold inside the housing including a vertically extending portion that vertically extends along a side portion of the housing, the cooling manifold being connected to each of the cooling plates; a leakage protection member enclosing at least a portion of the cooling manifold, the leakage protection member extending toward a bottom portion of the housing along the cooling manifold such that coolant that is leaked from the cooling manifold is drained through the leakage protection member toward the bottom portion of the housing; and a detection unit including at least one leakage sensor positioned at the bottom portion of the housing and configured to detect coolant drained toward the bottom portion by the leakage protection member.

### CROSS-REFERENCE-TO RELATED APPLICATION

The present application claims priority to and the benefit of European Patent Application No. 24159433.2, filed on Feb. 23, 2024, in the European Patent Office, the entire disclosure of which is incorporated herein by reference.

### BACKGROUND

### 1. Field

Aspects of the present disclosure relate to a battery system with an integrated cooling manifold in the housing, and a vehicle including the same.

### 2. Description of the Related Art

Recently, vehicles for transportation of goods and people have been developed using electric power as a source for motion. Such an electric vehicle is an automobile that is capable of being propelled by an electric motor, using energy stored in rechargeable batteries. An electric vehicle may be solely powered by batteries (such as in a battery electric vehicle (BEV)) or may include a combination of an electric motor and, for example, a conventional combustion engine (such as in a plugin hybrid electric vehicle (PHEV)). BEVs and PHEVs use high-capacity rechargeable batteries, which are designed to give power for propulsion over sustained periods of time.

Generally, a rechargeable (or secondary) battery cell includes an electrode assembly including a positive electrode, a negative electrode, and a separator interposed between the electrodes. A solid or liquid electrolyte allows movement of ions during charging and discharging of the battery cell. The electrode assembly is located in a casing and electrode terminals, which are positioned on the outside of the casing, establish an electrically conductive connection to the electrodes. The shape of the casing may be, for example, cylindrical or rectangular.

A battery module is formed of a plurality of battery cells connected in series or in parallel. That is, the battery module is formed by interconnecting the electrode terminals of the plurality of battery cells depending on a required amount of power and in order to realize a high-power rechargeable battery.

Battery modules can be constructed in either a block design or in a modular design. In the block design each battery is coupled to a common current collector structure and a common battery management system and the unit thereof is arranged in a housing. In the modular design, pluralities of battery cells are connected together to form submodules and several submodules are connected together to form the battery module. In automotive applications, battery systems generally include a plurality of battery modules connected in series for providing a desired voltage.

A battery pack is a set of any number of (e.g., identical) battery modules or single battery cells. The battery modules, respectively battery cells, may be configured in a series, parallel or a mixture of both to deliver the desired voltage, capacity, and/or power density. Components of a battery pack include the individual battery modules, and the interconnects, which provide electrical conductivity between the battery module.

A battery system may also include a battery management system (BMS), which is any suitable electronic system that is configured to manage the rechargeable battery, battery module, and battery pack, such as by protecting the batteries from operating outside their safe operating area, monitoring their states, calculating secondary data, reporting that data, controlling their environment, authenticating them and/or balancing them. For example, the BMS may monitor the state of the battery as represented by voltage (e.g., a total voltage of the battery pack or battery modules and/or voltages of individual cells), temperature (e.g., an average temperature of the battery pack or battery modules, coolant intake temperature, coolant output temperature, and/or temperatures of individual cells), coolant flow (e.g., flow rate and/or cooling liquid pressure), and current. Additionally, the BMS may calculate values based on the above parameters, such as minimum and maximum cell voltages, state of charge (SOC) or depth of discharge (DOD) to indicate the charge level of the battery, state of health (SOH; a variously-defined measurement of the remaining capacity of the battery as % of the original capacity), state of power (SOP; the amount of power available for a defined time interval given the current power usage, temperature and other conditions), state of safety (SOS), maximum charge current as a charge current limit (CCL), maximum discharge current as a discharge current limit (DCL), and internal impedance of a cell (to determine open circuit voltage).

The BMS may be centralized such that a single controller is connected to the battery cells through a multitude of wires. In other examples, the BMS may be also distributed, with a BMS board is installed at each cell, with just a single communication cable between the battery and a controller. In yet other examples, the BMS may have a modular construction including a few controllers, each handling a certain number of cells, while communicating between the controllers. Centralized BMSs are most economical, but are least expandable, and are plagued by a multitude of wires. Distributed BMSs are the most expensive, but are simplest to install, and offer the cleanest assembly. Modular BMSs provide a compromise of the advantages and disadvantages of the other two topologies.

The BMS may protect the battery pack from operating outside its safe operating area. Operation outside the safe operating area may be indicated in case of over-current, over-voltage (during charging), over-temperature, under-temperature, over-pressure, and ground fault or leakage current detection. The BMS may prevent operation outside of the battery's safe operating area by including an internal switch (such as a relay or solid-state device), which is opened if the battery is operated outside its safe operating area, requesting the devices to which the battery is connected to reduce or even terminate using the battery, and actively controlling the environment, such as heaters, fans, air conditioning, or liquid cooling means.

Battery systems according to the related art, despite any modular structure, usually include a battery housing that serves as enclosure to seal the battery system against the environment and provides structural protection of the battery system's components. Housed battery systems are usually mounted as a whole into their application environment, e.g., an electric vehicle. Thus, the replacement of defective system parts, e.g., a defective battery submodule, includes dismounting the whole battery system and removal of its housing first. Even defects of small and/or cheap system parts might then lead to dismounting and replacement of the complete battery system and its separate repair. As high-capacity battery systems are expensive, large and heavy, said procedure proves burdensome and the storage, e.g., in the mechanic's workshop, of the bulky battery systems becomes difficult.

To provide thermal control of the battery pack, a thermal management system is utilized to safely use the at least one battery module by efficiently emitting, discharging, and/or dissipating heat generated from its rechargeable batteries. If the heat emission, discharge, and/or dissipation is not sufficiently performed, temperature deviations may occur between respective battery cells, such that the battery module may no longer generate a desired amount of power. In addition, an increase of the internal temperature can lead to abnormal reactions occurring therein, and thus, charging, and discharging performance of the rechargeable deteriorates and the life-span of the rechargeable battery is shortened. Thus, cell cooling for effectively emitting, discharging, and dissipating heat from the cells is important.

In battery systems, for example automotive battery systems (e.g., high voltage, HV-) battery systems, one or more cooling manifold units are usually located outside of a housing to supply a battery pack and coolant plates therein with a coolant and to drain the used coolant from the battery pack. This configuration is utilized because the coolant can leak out of the cooling manifold at manifold defects or interfaces thereof. In the event of leakage failure, the coolant can cause a short circuit at the high and also at low voltage areas which may result in operation failure or even hazardous battery states. Therefore, an external configuration is safe in terms of leakage failure because HV components cannot be affected by leakage. However, this configuration utilizes additional space and prevents a compact integration.

### SUMMARY

Aspects of the present disclosure are directed to a battery system and a vehicle including the battery system.

According to some embodiments, there is provided a battery system including: a plurality of accommodation chambers on top of each other in a housing with a plurality of side portions, each one of the accommodation chambers including a plurality of battery cells and a cooling plate; a cooling manifold inside the housing including a vertically extending portion that vertically extends along a side portion of the housing, the cooling manifold being connected to each of the plurality of cooling plates; a leakage protection member enclosing at least a portion of the cooling manifold, the leakage protection member extending toward a bottom portion of the housing along the cooling manifold such that coolant that is leaked from the cooling manifold is drained through the leakage protection member toward the bottom portion of the housing; and a detection unit including at least one leakage sensor positioned at the bottom portion of the housing and configured to detect coolant drained toward the bottom portion by the leakage protection member.

In some embodiments, the cooling manifold may be connected to each of the plurality of cooling plates through interfaces, and the leakage protection member may further cover the interface, such that the interface is enclosed by the leakage protection member, the leakage protection member being configured to drain coolant that is leaked from the interface toward the bottom portion of the housing.

In some embodiments, the cooling manifold may include manifold branch portions that branch from the vertically extending portion toward the interfaces to the cooling plates, and the leakage protection member may include a leakage protection branch portion that encloses the manifold branch portion and the interface.

In some embodiments, the leakage protection member may be integrally formed.

In some embodiments, the leakage protection member may be made of a flexible plastic.

In some embodiments, the leakage protection member may be connected to at least one side portion of the housing to seal an interface between two side portions.

In some embodiments, the leakage protection member may extend toward the bottom portion of the housing, such that an end portion directed toward the bottom portion is closer to the bottom portion than high-voltage components of the battery system.

In some embodiments, the end portion of the leakage protection member may be spaced from the bottom portion of the housing.

In some embodiments, the battery system further may include a plurality of leakage sensors located at different positions of the bottom portion.

In some embodiments, the at least one leakage sensor may include a voltage supply and two electrical sensing elements spaced from each other with respect to the bottom portion of the housing and connected to the voltage supply, and the detection unit may be configured to detect coolant in response to determining a resistance drop and/or current increase between the sensing elements due to the presence of coolant.

In some embodiments, the at least one sensor may include an electrical resistor connected in parallel to the sensing elements, and the resistance value of the electrical resistor may be higher than the resistance value across the electrical sensing elements in the presence of coolant.

In some embodiments, the sensing elements and/or an area between the sensing elements may be enclosed by a casing, and the casing includes an opening configured to allow coolant to enter through the opening.

In some embodiments, the at least one sensor may further include a rib that is positioned in the area between the sensing elements.

In some embodiments, the at least one sensor may further include a plurality of trenches on the rib.

According to some embodiments, a vehicle may include the battery system described above.

### BRIEF DESCRIPTION OF THE DRAWINGS

Features will become apparent to those of ordinary skill in the art by describing in detail exemplary embodiments with reference to the attached drawings in which:

FIG. 1 illustrates a schematic front view of a battery pack/system according to some embodiments of the present disclosure,

FIG. 2A illustrates a schematic front view of a battery pack/system according to some embodiments of the present disclosure,

FIG. 2B illustrates a schematic view of a detection unit according to some embodiments of the present disclosure,

FIG. 3 illustrates a schematic perspective view of a battery pack/system according to some embodiments of the present disclosure,

FIG. 4 illustrates a schematic view of a leakage protection member according to some other embodiments of the present disclosure,

FIG. 5 illustrates a schematic perspective view of a leakage sensor according to some embodiments of the present disclosure,

FIG. 6 illustrates a schematic perspective view of a leakage sensor according to some other embodiments of the present disclosure,

FIG. 7 illustrates a schematic perspective view of a leakage sensor according to some other embodiments of the present disclosure, and

FIG. 8 illustrates a schematic perspective view of a leakage sensor according to some other embodiments of the present disclosure.

### DETAILED DESCRIPTION

Reference will now be made in detail to embodiments, examples of which are illustrated in the accompanying drawings. Effects and features of the exemplary embodiments, and implementation methods thereof will be described with reference to the accompanying drawings. In the drawings, like reference numerals denote like elements, and redundant descriptions are omitted. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described. In the drawings, the relative sizes of elements, layers, and regions may be exaggerated for clarity.

As used herein, the term “and/or” includes any and all combinations of one or more of the associated listed items. Further, the use of “may” when describing embodiments of the present disclosure refers to “one or more embodiments of the present disclosure.” In the following description of embodiments of the present disclosure, the terms of a singular form may include plural forms unless the context clearly indicates otherwise.

It will be understood that although the terms “first” and “second” are used to describe various elements, these elements should not be limited by these terms. These terms are only used to distinguish one element from another element. For example, a first element may be named a second element and, similarly, a second element may be named a first element, without departing from the scope of the present disclosure.

It will be further understood that the terms “include,” “comprise,” “including,” or “comprising” specify a property, a region, a fixed number, a step, a process, an element, a component, and a combination thereof but do not exclude other properties, regions, fixed numbers, steps, processes, elements, components, and combinations thereof. It will also be understood that when a film, a region, or an element is referred to as being “above” or “on” another film, region, or element, it can be directly on the other film, region, or element, or intervening films, regions, or elements may also be present.

Herein, the terms “upper” and “lower” are defined according to the z-axis. For example, the upper cover is positioned at the upper part of the z-axis, whereas the lower cover is positioned at the lower part thereof. In the drawings, the sizes of elements may be exaggerated for clarity. For example, in the drawings, the size or thickness of each element may be arbitrarily shown for illustrative purposes, and thus the embodiments of the present disclosure should not be construed as being limited thereto.

The electronic or electric devices and/or any other relevant devices or components according to embodiments of the present disclosure described herein may be implemented utilizing any suitable hardware, firmware (e.g., an application-specific integrated circuit), software, or a combination of software, firmware, and hardware. Further, the various components of these devices may be implemented on a flexible printed circuit film, a tape carrier package (TCP), a printed circuit board (PCB), or formed on one substrate. The electrical connections or interconnections described herein may be realized by wires or conducting elements, e.g., on a PCB or another kind of circuit carrier. The conducting elements may include metallization, e.g., surface metallizations and/or pins, and/or may include conductive polymers or ceramics. Further electrical energy might be transmitted via wireless connections, e.g., using electromagnetic radiation and/or light.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like.

Also, a person of skill in the art should recognize that the functionality of various computing devices may be combined or integrated into a single computing device, or the functionality of a particular computing device may be distributed across one or more other computing devices without departing from the scope of the exemplary embodiments of the present disclosure.

According to some aspects of the present disclosure, a battery system is provided which includes a plurality of accommodation chambers that are disposed on (e.g., positioned or located on) top of each other in a housing, wherein each accommodation chamber includes a plurality of battery cells and a cooling plate is associated to the accommodation chamber. The battery system includes a cooling manifold that is disposed (e.g., positioned or located) inside the housing. The cooling manifold includes a vertically extending portion which vertically extends along a side portion of the housing. The cooling manifold is connected to each of the plurality of cooling plates. A leakage protection member is provided which encloses at least a portion of the cooling manifold, wherein the leakage protection member extends toward a bottom portion of the housing along the cooling manifold such that coolant that is leaked from the cooling manifold is drained through the leakage protection member toward the bottom portion of the housing. The leakage protection member is formed and configured to drain coolant that is leaked from the cooling manifold toward a bottom portion of the housing. Further, a detection unit is provided which includes at least one leakage sensor positioned at the bottom portion of the housing. The detection unit is configured to detect coolant drained toward the bottom portion by the leakage protection member.

The leakage protection member may be formed as a hollow body. The housing may be the housing of a battery system or battery pack. The leakage protection member may form a channel between the cooling manifold and the leakage protection member so that coolant can flow along the channel toward the bottom portion. The term enclosing may include sleeving or completely surrounding. The cooling manifold may be configured to supply coolant to the cooling plates and to receive coolant from the cooling plates, which was used in the cooling plate. A pump unit, such as an external pump unit, may be provided which enables a coolant flow through the cooling manifold and through the cooling plate. The bottom portion of the housing may be, in other words, a bottom plate. The coolant may be a liquid coolant.

The battery system as described above has an integrated cooling manifold in the housing. Despite of the cooling manifold being inside the housing, the leakage protection member enclosing the cooling manifold prevents the leaked coolant that can propagate outside of the leakage protection member. In fact, it is confined to flow in the channel formed between the leakage protection member and the cooling manifold. Thus, high-voltage components are protected from leaked coolant and even in the event of leakage failure in the cooling manifold, the battery system can still be safely operated. Because the leakage protection member extends to the bottom portion, the leaked coolant is drained to the bottom portion by using gravity. Further, because the at least one leakage sensor is provided on the bottom portion, a failure state indicating a leaking cooling manifold coolant can be readily detected by the detection unit using the leakage sensor because the leaked coolant is collected at the bottom portion. Therefore, compact integration is enabled (e.g., made possible) due to the internal cooling manifold, while also ensuring a safe operation of the battery system even in a failure case of coolant leakage from the cooling manifold. As well, the failure case can be readily detected by the battery system. Thus, a warning may be provided or a battery disconnection operation may be performed so that the failure state can be removed prior to continuing operations. The leakage protection member acts like a hose to drain the leaked coolant. In some examples, a flow channel may be provided to drain the coolant in the space between the cooling manifold and the enclosing leakage protection member.

According to some embodiments, the cooling manifold is connected to each of the plurality of cooling plates through an interface. The leakage protection member further covers the interface, such that the interface is enclosed by the leakage protection member. The leakage protection member is further configured to drain coolant that is leaked from the interface toward the bottom portion of the housing. The interface between the cooling manifold may be a weak spot at which coolant may easily leak even when properly connected. Leakage may also be caused by connection failure in installation or be caused during normal usage as the result of mechanical load or material deterioration. Thus, because the leakage protection member encloses the interface, leaked coolant is prevented from coming into contact with high voltage (HV) components or other electrical components of the battery system, and is drained away from the interface toward the bottom portion.

According to some other embodiments, the cooling manifold includes manifold branch portions. The interfaces to the cooling plates may be located at end portions of the manifold branch portions. The leakage protection member includes a leakage protection branch portion which encloses the manifold branch portions and the interfaces. Thus, the leakage protection member can be formed to also protect the manifold branch portions with the interface thereon. Thus, leakage protection is improved (e.g., increased) compared to an example in which the manifold branch portions are not enclosed the leakage protection member. The leakage protection member may function like a hose to drain the leaked coolant from the interface along the branch portion toward the bottom portion.

The cooling manifold includes manifold branch portions which branch from the vertically extending portion toward the interface to the cooling plates. The leakage protection member includes a leakage protection branch portion which encloses the manifold branch portion and the interface. The leakage protection branch portion may thus form a channel for the leaked coolant to be drained into the vertically extending leakage protection portion and then toward the bottom portion. The leakage protection branch portion may have a slope. This may facilitate drainage process of the leaked coolant toward the bottom portion. In some other embodiments, the branch portion is horizontal and the drainage based on the liquid pressure and confinement alone.

According to some embodiments, the leakage protection member is integrally formed (e.g., as a unitary, monolithic body). This has an effect of improved (e.g., increased) sealing compared to an example in which the leakage protection member includes a plurality of segments which utilize connection interfaces. Therefore, coolant leakage protection is further improved (e.g., increased). In some examples, the leakage protection member may include connected segments.

According to some embodiments, the leakage protection member is made of a flexible plastic. This allows to enclose non-straight parts of the cooling manifold. This material property is helps to enclose the branch portions and/or the interface portion, in particular in the monolithic (i.e., integral) example. In some other embodiments, silicone, rubber, and/or the like may be used.

According to some embodiments, the leakage protection member is connected to at least one side portion of the housing to seal an interface between two side portions of the housing. Thus, the leakage protection member can further be used to provide sealing to the side portions. Thus, the leakage protection member may seal the interface between side portions. Therefore, no further sealing member may be utilized besides the leakage protection member. In some examples, the leakage protection member provides two functions of coolant leakage sealing as well as sealing the housing.

According to some embodiments, the leakage protection member extends toward the bottom portion of the housing, such that an end portion directed toward the bottom portion is closer to the bottom portion than high-voltage components of the battery system. Thus, the leaked coolant flowing out of the leakage protection member cannot come into contact with high-voltage components of the battery system or battery pack. This increases operation safety.

According to some embodiments, the end portion of the leakage protection member is spaced from the bottom portion of the housing. This allows the leaked coolant to easily flow out of the leakage protection member onto the bottom portion of the housing, where the coolant can be detected. No further guiding structures may be utilized in such examples.

According to some embodiments, the battery system includes a plurality of leakage sensors located at different positions of the bottom portion. This ensures that leaked coolant may be detected also in an example in which the battery system is tilted, for example, when used in a vehicle at a slope. Further, redundancy is provided increasing functional safety.

According to some embodiments, the at least one leakage sensor includes a voltage supply and two electrical sensing elements spaced from each other on the bottom portion of the housing and connected to the voltage supply. The detection unit is configured to detect coolant in response to determining a resistance drop and/or current increase between the electrical sensing elements due to the presence of coolant. Thus, assuming that the coolant has electrically conductive properties (e.g., higher compared to air) the resistance across the electrical sensing elements is reduced. Thus, a larger current can flow across the electrical sensing elements compared to when air is between the electrical sensing elements. Therefore, determining that the resistance has dropped and/or that the current has increased indicates the presence of coolant. For example, the detection unit may detect a leaked coolant when a corresponding threshold (for resistance or current) is reached. In this manner, drained coolant which collects on the bottom portion of housing can be detected by the detection unit. The detection unit may include a control unit to evaluate the sensed data and to detect the leaked coolant. The electrical sensing elements may include sensing pads and/or the wires leading thereto. Also, the voltage supply may be provided in a sensor housing and the electrical sensing elements may be fixed to the sensor housing.

According to some embodiments, the at least one leakage sensor includes an electrical resistor such that the resistance value of the electrical resistor is higher than the resistance value across the electrical sensing elements in the presence of coolant. The electrical resistor may be connected in parallel to the electrical sensing elements. Higher may mean by a factor of more than 10 or by a factor of more than 100 or more than 1000. The resistance value across the electrical sensing elements in the presence of coolant may also be referred to as the expected resistance of the leaked liquid. Due to the additional resistance value, an open wire fault may be detected. Thus, the reliable functioning of the sensor can be tested. Further, depending on the functional safety requirements, two or more independent channels can be used for redundancy. Thus, functional safety can be increased.

According to some embodiments, the battery system may further include a rib that is positioned in the area between the sensing elements. The rib may be a block. The rib may increase the creepage distance between sensing elements so to decrease sensitivity to moisture and/or condensation to avoid a false detection. The rib may be, in other words, a block.

According to some embodiments, the rib includes a plurality of trenches. The trenches may be formed on an upper surface of the rib and/or a lower surface of the rib. This may further decrease the sensitivity to moisture and/or condensation, thus effectively increasing the creepage distance to avoid a false detection.

According to some embodiments, the leakage protection member includes an increased air gap between the sensing elements. For example, the distance between the sensing elements may be the width of the sensor housing. Therefore, the sensitivity to moisture and/or condensation may be further decreased to avoid a false detection.

According to some embodiments, the electrical sensing elements and/or an area between the electrical sensing elements is encased by a plastic housing, wherein the plastic housing includes an opening configured to allow coolant to enter through the opening. The opening may be configured to allow only the coolant to enter. Thus, dust and pollution may be prevented from affecting the detection. Thus, the sensitivity to pollution and dust may be decreased.

According to some aspect of the present disclosure, a vehicle including the battery system is provided.

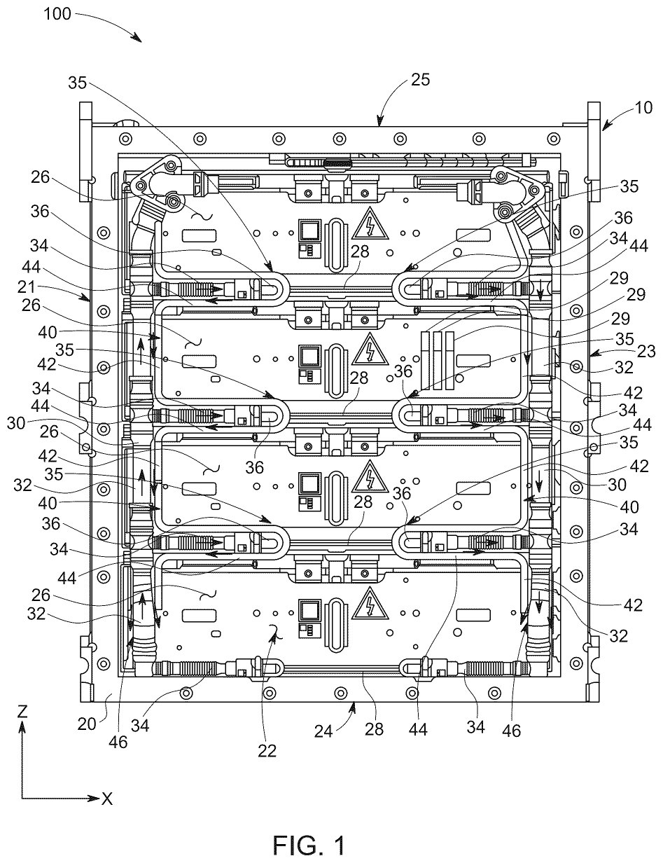

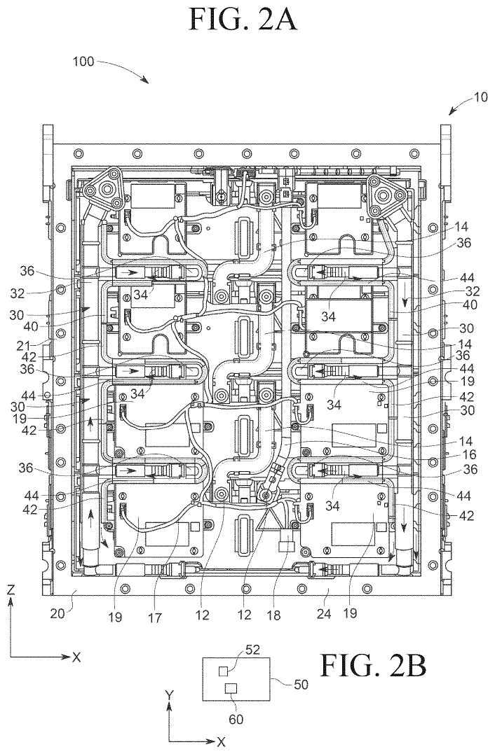

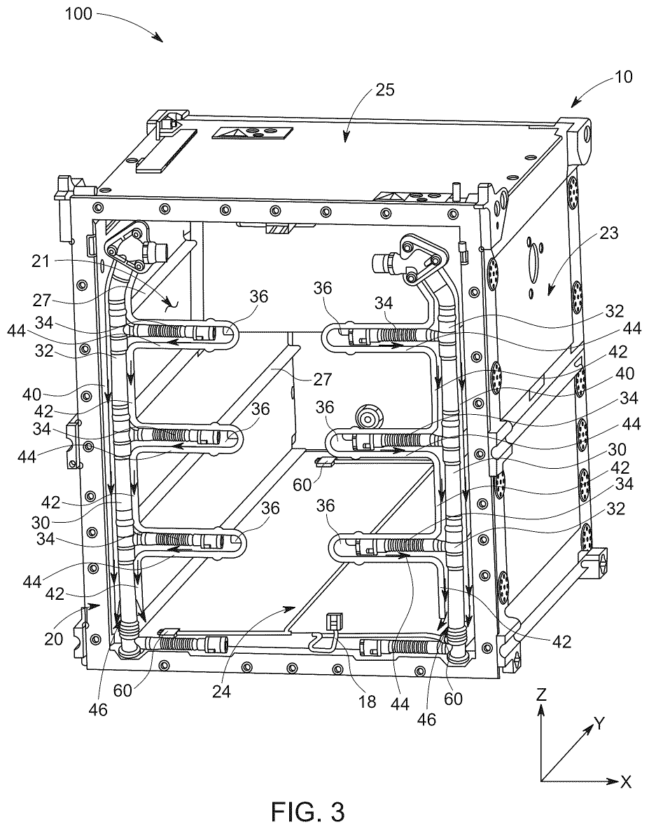

FIG. 1 shows a front view illustrating a battery system 100 and a battery pack 10, according to some embodiments of the present disclosure. FIG. 2A shows a front view illustrating a battery system 100 and a battery pack 10 where a front cover is removed so that interior components of the battery pack 10 can be seen, according to some embodiments of the present disclosure. FIG. 2B illustrates a schematic view of a detection unit according to some embodiments of the present disclosure. FIG. 3 shows a perspective view of a battery system 100 in which a subset of interior components are removed for further illustration, according to some embodiments of the present disclosure.

In the following, the description may refer to FIGS. 1 to 3 in parallel for illustrating the present disclosure in more detail.

Referring to FIG. 1, the battery pack 10, and in the same way, the battery system 100 includes a housing 20. The housing 20 includes a plurality of side portions 21, . . . , 23, i.e., a first side portion 21, a second side portion 22, a third side portion 23, and a fourth side portion (not shown here due to the front view). The first side portion 21 and the third side portion 23 may face each other (e.g., be opposite one another) and the second side portion 22 and the fourth side portion may face each other (e.g., be opposite one another). In the present view, the second side portion 22 may be a front portion and the fourth side portion may be a back portion. However, the front portion and the back portion may be exchanged (e.g., are interchangeable) with one another. Further, the housing 20 may include a bottom portion 24 and a top portion 25 as indicated in FIGS. 1 to 3.

Referring to FIG. 1, the housing 20 includes a plurality of accommodation chambers 26. In the present example, four accommodation chambers 26 are provided. Referring to FIGS. 1 and 2, the accommodation chambers 26 are disposed on (e.g., positioned or located on) top of each other. In the present view, only projections thereof are indicated. The accommodation chambers 26, as demonstrated in FIG. 3, may be divided by support members 27 extending along the side portions 21, 23.

Each of the accommodation chambers 26 include a plurality of battery cells 29. Also here, only projections of the battery cells 29 are provided. The battery cells 29 may be located at set or predetermined positions and interconnected with each other in a predefined manner. However, the present disclosure is not restricted to a particular arrangement of the battery cells 29 therein.

In the above example, for each accommodation chamber 26, a cooling plate 28 is provided. For example, the cooling plate 28 may be provided as a bottom portion for each accommodation chamber 26 as indicated in FIGS. 1 and 2. The cooling plate 28 may include cooling channels so that coolant flowing through the cooling plate 28 can dissipate heat therefrom.

Referring to FIGS. 1 to 3, a cooling manifold 30 is provided which is disposed (e.g., positioned or located) inside the housing 20. The cooling manifold 30 supplies coolant to the cooling plates 28.

The cooling manifold 30 further includes a vertically extending portion 32. The vertically extending portion 32 extends in vertical direction (e.g., z-direction) along the side portions 21, . . . , 23 of the housing 20. Referring to FIG. 3 as well as FIGS. 1 and 2, the cooling manifold 30 is located at a corner between the first side portion 21 and the second side portion 22. Further, the cooling manifold 30 is located in a corner between the second side portion 22 and the third side portion 23. However, the disclosure is not restricted thereto and the cooling manifold 30 may be located at other corners or other locations at the side portions 21, 22, and 23.

Further, the cooling manifold 30 is connected to each of the plurality of cooling plates 28. Each cooling plate 28 may include a coolant inlet and a coolant outlet. Thus, the coolant can be supplied via the cooling manifold 30 into the cooling plate 28 through the coolant inlet and can be drained through the coolant outlet from the cooling plate 28 via the cooling manifold 30. An exemplary flow path of the coolant through the cooling manifold 30 is illustrated in FIGS. 1 and 2 for mere illustrative purposes. However, there may be a problem of a leakage failure in the cooling manifold 30.

The battery system 100 may include various electrical components including high voltage (HV) components. An interior of the battery system 100 can be seen in FIG. 2A where covers are not shown for ease of illustration purposes.

Referring to FIG. 2A, an HV supply module/component 12 for the battery system 100 is provided. Furthermore, a plurality of HV busbars 14 and an HV return 16 are provided as examples of HV components of the battery system 100. In further addition thereto, a low voltage supply 18 is provided from which low voltage cables 17 are supplied to battery management units 19 of the battery system 100 or other power consumers as illustrated in FIG. 2A. However, the electrical components including HV components may have various suitable configurations, and the invention is not restricted to the particular configuration as illustrated in FIG. 2A.

The HV components but also the low components should not come into contact with leaked coolant. The present disclosure prevents such contact as will be described further below.

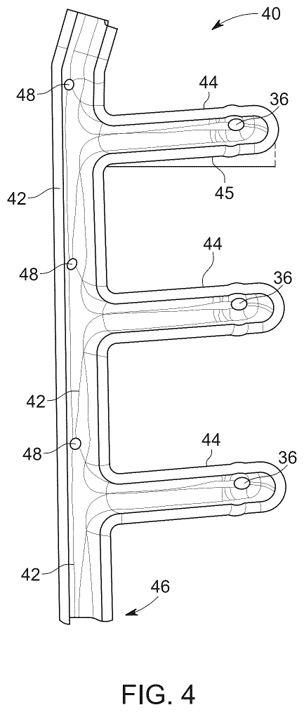

The battery system 100 includes a leakage protection member 40. The leakage protection member 40 may be a hollow body. This can be seen more clearly in FIGS. 3 and 4. An individual leakage protection member 40 according to some embodiments is further shown in FIG. 4.

Referring to FIGS. 1 to 3, the leakage protection member 40 encloses at least a portion of the cooling manifold 30. That is, the leakage protection member 40 covers the portion of the cooling manifold 30. The leakage protection member 40 extends to the bottom portion 24 of the housing 20. Further, the leakage protection member 40 is configured to drain coolant that is leaked from the cooling manifold 30 toward the bottom portion 24 of the housing 20. A flow of leaked coolant is illustrated in FIGS. 1, 2, and 3 by several arrows. The leakage protection member 40 thus forms a channel or hose for leaked coolant to be drained to the bottom portion 24 of the housing 20 between the cooling manifold 30 and the leakage protection member 40.

Because the leakage protection member 40 encloses a portion of the cooling manifold 30 toward the bottom portion 24 of the housing 20, a leakage occurring in this enclosed portion is drained to the bottom portion 24 of the housing 20. Thus, the leakage protection member 40 prevents direct contact between the coolant and the electronic components in the housing 20, such as HV components.

In addition, a detection unit 50 is provided which works together with the leakage protection member 40. In FIG. 2B, the detection unit 50 is schematically shown. The detection unit 50 includes at least one leakage sensor 60 positioned at the bottom portion 24 of the housing 20. Referring to FIG. 3, for example, four leakage sensors 60 are provided at different locations of the bottom portion 24 as illustrated therein.

The leakage sensor 60 is configured to detect coolant that is leaked from the cooling manifold 30 and drained toward the bottom portion 24 by the leakage protection member 40. Thus, when a leakage failure has occurred in the cooling manifold 30 and the leaked coolant has drained to the bottom portion 24, the leakage sensor 60 can sense the leakage failure. That is, the leakage protection member 40 guides the leaked coolant toward the leakage sensors 60 onto the bottom portion 24. The evaluation of the sensor signals and the leakage detection may be performed by a control unit 52 of the detection unit 50.

Further, referring to FIGS. 1 and 2, the cooling manifold 30 is connected to each of the plurality of cooling plates 28 through interfaces 36. The interfaces 36 refer to the coolant inlets and coolant outlets of the cooling manifold 30 and the cooling plate 28 and thus form the transition between the cooling manifold 30 and the cooling plate 28. Thus, for each cooling plate 28, two interfaces 36 are provided at which the cooling manifold 30 is connected with the respective cooling plate 28. Leakage failure at the interfaces 36 may however occur.

Referring to FIGS. 1, 2, and 3, the leakage protection member 40 may cover the interface 36 so that the interface 36 is enclosed by the leakage protection member 40. This is also illustrated in FIG. 4 in which the leakage protection member 40 covers the interfaces 36. Therefore, the leakage protection member 40 is further configured to drain coolant that is leaked from the interfaces 36 toward the bottom portion 24 of the housing 20. Arrows indicating a leakage flow path are for example best illustrated in FIG. 3.

Thus, also the interfaces 36 are protected from leaking and the leaked coolant is drained to the bottom portion 24 while preventing a contact of the leaked coolant with the electrical components of the battery pack 10 and battery system 100. A leakage flow path is illustrated in the FIGS. 1-3. To guide the leaked coolant to the bottom portion 24, the leakage protection member 40 includes a vertically extending leakage protection portion 42, which extends along a portion of the cooling manifold 30 toward the bottom portion 24.

In more detail and referring to FIGS. 1-3, the cooling manifold 30 includes manifold branch portions 34. These manifold branch portions 34 branch off from the vertically extending portions 32 toward the interfaces 36 to the cooling plates 28 as indicated in FIGS. 1-3. The interfaces 36 to the cooling plates 28 are located at the manifold branch portions 34 and, for example, may be formed at end portions 35 thereof.

As shown in FIG. 4, the leakage protection member 40 includes a leakage protection branch portion 44. This leakage protection branch portion 44 encloses the manifold branch portions 34 of the cooling manifold 30. The leakage protection branch portion 44 may have a slope of about 45 degrees, so that drainage of leaked coolant toward the bottom portion 24 is facilitated. However, in some other embodiments, the leakage protection branch portion 44 may be horizontal and the flow is caused by coolant pressure and the confinement in the leakage protection branch portion 44.

The leakage protection member 40 encloses the manifold branch portions 34 and the interfaces 36. Thus, the leakage protection member 40 is formed to enclose the manifold branch portions 34 together with the interfaces 36 to prevent leakage from these parts (e.g., these critical parts) and thereby safely drains leaked coolant toward the bottom portion 24 where it can be detected.

Referring to FIG. 4, the leakage protection member 40 is integrally formed (e.g., as a unitary, monolithic body). This implies that the leakage protection member 40 does not include internal interfaces but is a continuous hollow body. Therefore, the leakage protection member 40 has optimal sealing properties and coolant is protected from leaking out of the leakage protection member 40.

The leakage protection member 40 may have a shape as shown in FIG. 4. The leakage protection member 40 may be made of a flexible plastic. Thus, the leakage protection member 40 may easily withstand bending and may have improved (e.g., increased) sealing property at the interface 36 of the cooling plate 28 and the branch point, where the flexible property helps to seal the interface 36.

The leakage protection member 40 may further provide an additional function. In some embodiments, the leakage protection member 40 is connected to at least one side portion 21/, . . . /23 of the housing 20 to seal an interface between two side portions (e.g., adjacent side portions 21 and 22). For example, the leakage protection member 40 seals the interface between the first side portion 21 and the second side portion 22. In another example, the leakage protection member 40 may seal the interface between the second side portion 22 and the third side portion 23. Thus, additional sealing members may be avoided or at least reduced. As shown in FIG. 4, fixation holes 48 are provided in the leakage protection member 40.

Referring again to FIGS. 1 to 3, the leakage protection member 40 extends toward the bottom portion 24 of the housing 20 such that an end portion 46 directed toward the bottom portion 24 is closer to the bottom portion 24 than high-voltage components integrated in the housing 20. As shown in FIG. 2A, the end portion 46 of the leakage protection member 40 is closer to the bottom portion 24 than for example the HV supply module/component 12 and/or the HV busbars 14. Thus, the coolant leaked toward the bottom portion 24 cannot contact the high-voltage components in the housing 20.

Further as shown in FIGS. 1 to 3, the end portion 46 of the leakage protection member 40 is spaced from the bottom portion 24 of the housing 20. Thus, the leaked coolant can simply flow out and be collected on the bottom portion 24 to be detected by the leakage sensors 60.

According to FIG. 3, a plurality of leakage sensors 60 located at different positions of the bottom portion 24 are provided. This may have the advantage that also in a use case where the battery pack 10 or battery system 100 is slightly tilted, drained liquid may be detected by at least one of the leakage sensors 60 where the coolant is collecting. Further, functional safety is improved (e.g., increased) due to redundancy.

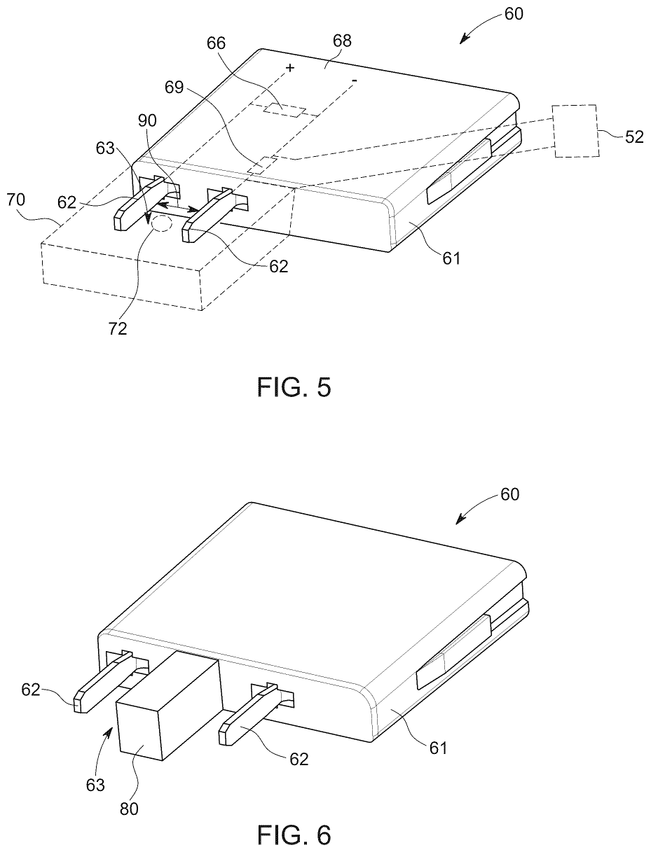

Referring now to FIGS. 5 to 8, leakage sensors 60 according to various embodiments of the disclosure are shown. The general function is described with respect to FIG. 5. The leakage sensor 60 is configured to sense drained coolant as described in the following.

The at least one leakage sensor 60 may include a voltage supply 68. The voltage supply 68 may be an internal supply or an external supply provided to the leakage sensor 60. For example, the leakage sensor 60 may be connected to the low voltage supply 18 as shown in FIG. 3. In the embodiment of FIG. 5, the voltage supply 68 is provided in a sensor housing 61.

According to some embodiments, the leakage sensor 60 includes two electrical sensing elements 62 fixed to the sensor housing 61. The electrical sensing elements 62, e.g., pads, may be spaced from each other with respect to the bottom portion 24 of the housing 20 so that they are spatially separated from each other by a distance 90. Further, the two electrical sensing elements 62 are connected to the voltage supply 68. Thus, when no coolant is present, an air gap exists between the electrical sensing elements 62 so that the electrical resistance value is high across the electrical sensing elements 62.

When leaked coolant is collected on the bottom portion 24 according to the various embodiments as described above, the coolant may be collected between the electrical sensing elements 62 thereby displacing air from an area 63 between the sensing elements 62. Thus, because the coolant is a liquid with higher conductivity than air, the resistance value across the electrical sensing elements 62 may be reduced. Thus, the leakage sensor 60 may sense the presence of coolant on the bottom portion 24.

Therefore, because the resistance value is reduced and the electrical current increased in the presence of the coolant as described above, the detection unit 50 including the leakage sensor 60 can detect the leaked coolant in response to determining a resistance drop and/or current increase between the sensing elements 62 due to the presence of drained coolant. A shunt resistor 69, along with for example an amplifier connected to the shunt resistor 69, may be provided to probe the current and/or the resistance. However, also other ways of determining the current/and or resistance may be provided. Further, threshold values may be provided to distinguish from common variations. The evaluation may be performed by a control unit 52, e.g., by an integrated battery management unit in the battery pack or battery system or by a central/another controller.

Further, referring to FIG. 5, the leakage sensor 60 may further include an electrical resistor 66 for open wire fault detection. The resistance value of the electrical resistor 66 is set higher than the resistance value across the electrical sensing elements 62 in the presence of coolant, for example by a factor of more than 10, more than 100, or more than 1000. Therefore, the resistance value may be set or predetermined to be higher (e.g., by the above factors) than the expected resistance value in the presence of the coolant being collected between the electrical sensing elements 62.

The electrical resistor 66 may, for example, be provided in parallel to the voltage supply 68. Thus, for example, in case of open wire fault and in the presence of coolant, a small set or predetermined current across the parallel electrical resistor 66 may be detected instead of the current across the sensing elements 62. Therefore, the electrical resistor 66 may be used to detect an open wire fault when being equipped with the fixed electrical resistor 66 of significantly higher resistance value than the expected resistance of the leaked coolant. Further, depending on the functional safety requirements, two or more independent channels (FIG. 5 showing one channel) can be used for redundancy.

Further, referring again to FIG. 5, the sensing elements 62 and/or the area 63 between the sensing elements 62 is enclosed by a casing 70. The casing 70 may be a plastic casing. In FIG. 5, the casing 70 is indicated by dashed lines.

The casing 70, as can be seen in FIG. 5, includes an opening 72. The opening 72 is configured to allow coolant to enter the casing 70 through the opening 72. Thus, the opening 72 may have a size such that coolant can enter the casing 70 to reach the sensing elements 62. However, in such examples, dust and pollution may be prevented from contacting the sensing elements 62. Thus, sensitivity to dust and pollution can be reduced, according to some embodiments.

Referring to FIG. 6, a leakage sensor 60 according to some other embodiments is provided. The embodiment can be combined with the various embodiments as described with respect to FIG. 5. The leakage sensor 60 may further include a rib 80 or block that is positioned in the area 63 between the sensing elements 62. Thus, because moisture and condensation may be present inside the housing 20, the rib 80 may increase creepage distance. Thus, sensitivity to moisture and condensation in the housing 20 is reduced by placing the rib 80 in the area 63 between the sensing elements 62 so that only an actual event of coolant leakage is detected.

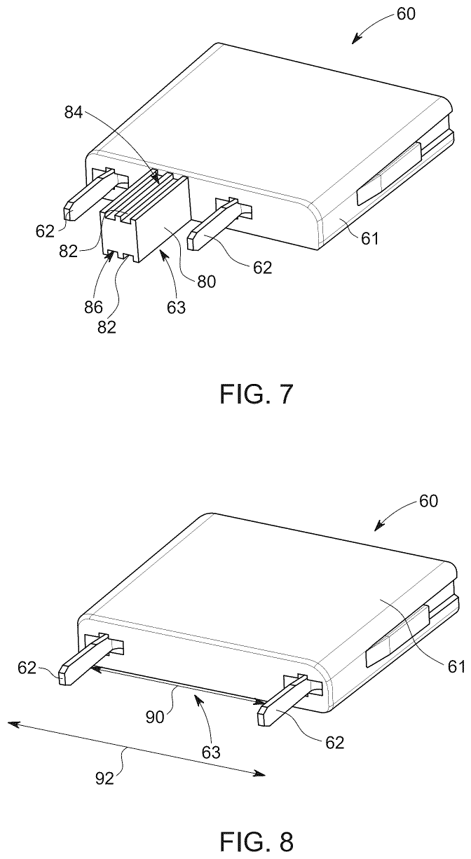

Referring to FIG. 7, a leakage sensor 60 according to some other embodiments is provided. The embodiment can be combined with the various embodiments as described with respect to FIG. 5 and FIG. 6. Referring to FIG. 7, the leakage sensor 60 may further include a plurality of trenches 82 on the rib 80. For example, trenches 82 may be formed on an upper surface 84 of the rib 80. The trenches 82 may hold condensed moisture and condensation to prevent contact between the sensing elements 62 by condensates or moisture. This may further increase creepage distance. Further, trenches 82 may be formed on lower surface 86 of the rib 80 for further increasing creepage distance. FIG. 7 shows examples in which the trenches 82 are formed on both the upper surface 84 and the lower surface 86 of the rib 80.

Referring to FIG. 8, a leakage sensor 60 according to some other embodiments is provided. These embodiments can be combined with the various embodiments as described with respect to FIGS. 5 to 7. The leakage sensor 60 may 1 provide an increased distance 90 between the leakage sensor (e.g., sensing elements) 60. For example, the distance 90 may correspond to a width 92 of the sensor housing 61 and thus increases separation. This may further increase creeping distance and reduce the sensitivity to moisture and condensation in the battery pack 10.

In some further embodiments, a vehicle including the battery system 100, according to any of the above embodiments.

In summary, a battery system 100 and a battery pack 10 is provided with an integrated cooling manifold 30 inside the housing 20. Despite of the cooling manifold 30 being inside the housing 20, the leakage protection member 40 enclosing the cooling manifold 30 prevents the leaked coolant that can propagate outside of the leakage protection member, and because the leakage protection member 40 extends to the bottom portion 24, the leaked coolant can be readily detected by leakage sensors 60. The leaked coolant flow is confined to flow in the channel formed between the leakage protection member 40 and the cooling manifold 30. Thus, high-voltage components 12, 14, are 16 are protected from leaked coolant and even in the event of a leakage failure in the cooling manifold, the battery system can still be safely operated. Therefore, a compact integration is provided due to the internal cooling manifold 30 while ensuring safe operation and leakage detection.

### SOME REFERENCE SYMBOLS

10 battery pack
12 HV supply module (HV component)
14 HV busbar (HV component)
16 HV return (HV component)
17 low voltage (LV) cable
18 low voltage (LV) supply
19 battery management unit (BMU)
20 housing
21 first side portion
22 second side portion
23 third side portion
24 bottom portion
25 top portion
26 accommodation chamber
27 support member
28 cooling plate
29 battery cells
30 cooling manifold
32 vertically extending portion
34 manifold branch portion
35 end portion
36 interface
40 leakage protection member
42 vertically extending leakage protection portion
44 leakage protection branch portion
45 slope
46 end portion
48 fixation hole
50 detection unit
52 control unit
60 leakage sensor
61 sensor housing
62 sensing elements
66 electrical resistor
68 voltage supply
69 shunt resistor
70 casing
72 opening
80 rib
82 trench
84 upper surface
86 lower surface
90 distance
92 width
100 battery system

What is claimed is:

1. A battery system comprising:
a plurality of accommodation chambers on top of each other in a housing with a plurality of side portions, each one of the accommodation chambers comprising a plurality of battery cells and a cooling plate;
a cooling manifold inside the housing comprising a vertically extending portion that vertically extends along a side portion of the housing, the cooling manifold being connected to each of the plurality of cooling plates;
a leakage protection member enclosing at least a portion of the cooling manifold, the leakage protection member extending toward a bottom portion of the housing along the cooling manifold such that coolant that is leaked from the cooling manifold is drained through the leakage protection member toward the bottom portion of the housing; and
a detection unit comprising at least one leakage sensor positioned at the bottom portion of the housing and configured to detect coolant drained toward the bottom portion by the leakage protection member.

2. The battery system as claimed in claim 1, wherein the cooling manifold is connected to each of the plurality of cooling plates through interfaces, and
wherein the leakage protection member further covers an interface of the interfaces, such that the interface is enclosed by the leakage protection member, the leakage protection member being configured to drain coolant that is leaked from the interface toward the bottom portion of the housing.

3. The battery system as claimed in claim 2, wherein the cooling manifold comprises manifold branch portions that branch from the vertically extending portion toward the interfaces to the cooling plates, and
wherein the leakage protection member comprises a leakage protection branch portion that encloses the manifold branch portion and the interfaces.

4. The battery system as claimed in claim 1, wherein the leakage protection member is integrally formed.

5. The battery system as claimed in claim 1, wherein the leakage protection member is made of a flexible plastic.

6. The battery system as claimed in claim 1, wherein the leakage protection member is connected to at least one side portion of the housing to seal an interface between two side portions.

7. The battery system as claimed in claim 1, wherein the leakage protection member extends toward the bottom portion of the housing, such that an end portion directed toward the bottom portion is closer to the bottom portion than high-voltage components of the battery system.

8. The battery system as claimed in claim 7, wherein the end portion of the leakage protection member is spaced from the bottom portion of the housing.

9. The battery system as claimed in claim 1, further comprising a plurality of leakage sensors located at different positions of the bottom portion.

10. The battery system as claimed in claim 1, wherein the at least one leakage sensor comprises a voltage supply and two sensing elements spaced from each other with respect to the bottom portion of the housing and connected to the voltage supply, and
wherein the detection unit is configured to detect coolant in response to determining a resistance drop and/or current increase between the sensing elements due to presence of coolant.

11. The battery system as claimed in claim 10, wherein the at least one leakage sensor comprises an electrical resistor connected in parallel to the sensing elements, and
wherein a resistance value of the electrical resistor is higher than the resistance value across the sensing elements in the presence of coolant.

12. The battery system as claimed in claim 10, wherein the sensing elements and/or an area between the sensing elements is enclosed by a casing, and
wherein the casing comprises an opening configured to allow coolant to enter through the opening.

13. The battery system as claimed in claim 10, wherein the at least one leakage sensor further comprises a rib that is positioned in an area between the sensing elements.

14. The battery system as claimed in claim 13, wherein the at least one leakage sensor further comprises a plurality of trenches on the rib.

15. A vehicle comprising the battery system as claimed in claim 1.
